(19) United States
(12) Patent Application Publication
(10) Pub. No.: US 2024/0196195 A1
(43) Pub. Date: Jun. 13, 2024

(54) METHOD AND APPARATUS FOR MANAGING LINK FOR A MUSIM UE IN A WIRELESS COMMUNICATION SYSTEM

(71) Applicant: SAMSUNG ELECTRONICS CO., LTD., Suwon-si, Gyeonggi-do (KR)

(72) Inventors: Vinay Kumar SHRIVASTAVA, Bangalore (IN); Sangyeob JUNG, Suwon-si (KR); Himke VAN DER VELDE, Staines (GB)

(21) Appl. No.: 18/553,163

(22) PCT Filed: Mar. 29, 2022
(86) PCT No.: PCT/KR2022/004467

§ 371 Date: Sep. 28, 2023

(30) Foreign Application Priority Data
Mar. 30, 2021 (IN) 202141014477
Mar. 24, 2022 (IN) 202141014477

(51) Int. Cl. H04W 8/20; H04L 1/1822

(52) U.S. Cl. CPC H04W 8/205; H04L 1/1822

(57) ABSTRACT

The disclosure relates to a 5G or 6G communication system for supporting a higher data transmission rate. Embodiments herein provide method for link management for MUSIM UE (100) performing coordinated gaps. In another embodiment, the method includes sending UE assistance information message comprising at least one requested switching gap release by a gap index to first network apparatus (200a) in response to determining that the switching gap is not required, and receiving a MUSIM gap configuration comprising release of the switching gap with the gap index from the first network apparatus (200a). In another embodiment, the method includes sending a UE assistance information message comprising a preferred RRC state to the first network apparatus (200a) in response to determining that the RRC connection release or RRC connection release with suspend configuration is required, and receiving one of a RRC connection release and a RRC connection release with suspend configuration, wherein the preferred RRC state is one of an idle state, an inactive state, and a non-Connected state.

### TECHNICAL FIELD

The present disclosure relates to generally wireless communication system and, more specifically, the present disclosure relates to a MUSIM (multi-SIM) User Equipment's (UEs), in a wireless communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure provides method and apparatus for a MUSIM (multi-SIM) User Equipment's (UEs) in a wireless communication system.

### Solution to Problem

According to an aspect of an exemplary embodiment, there is provided a communication method in a wireless communication.

### Advantageous Effects of Invention

Aspects of the present disclosure provide efficient communication methods in a wireless communication system.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 is a sequence diagram illustrating link management for the MUSIM UE performing coordinated gaps, according to prior art;

FIG. 2 illustrates an overview of a wireless network, according to the embodiments as disclosed herein;

FIG. 3 illustrates various hardware components of a MUSIM UE, according to the embodiments as disclosed herein;

FIG. 4 is a flow chart illustrating a method for link management for the MUSIM UE performing coordinated gaps, according to the embodiments as disclosed herein;

FIG. 5 is a sequence diagram illustrating a method for link management for the MUSIM UE performing the coordinated gaps, according to the embodiments as disclosed herein;

FIG. 6 is a flow chart illustrating a method for link management for the MUSIM UE performing coordinated gaps based on timers, according to the embodiments as disclosed herein;

FIG. 7 is a flow chart illustrating a method for link management for the MUSIM UE performing coordinated gaps based on whether HARQ buffers are shared across two protocol stacks pertaining to two SIMs of the MUSIM UE, according to the embodiments as disclosed herein;

FIG. 8 is a flow chart illustrating a method for link management for the MUSIM UE performing coordinated gaps based on intermittent Rx operation and measurements and a CSI evaluation during the switching gap in accordance with resources as configured by the first network apparatus, according to the embodiments as disclosed herein;

FIG. 9 is a flow chart illustrating a method for link management for the MUSIM UE performing coordinated gaps based on SCell or SCG activation or deactivation or release, according to the embodiments as disclosed herein;

FIG. 10 is a flow chart illustrating a method for link management for the MUSIM UE performing coordinated gaps upon suspending at least one of a RA procedure, a SR procedure, a PHR reporting, a SI validation check or acquisition, and a PUCCH resource usage before or at the start of the switching gap, according to the embodiments as disclosed herein;

FIG. 11 is a flow chart illustrating a method for link management for the MUSIM UE performing coordinated gaps based on a change of paging configuration, reselection of a cell, an occurrence of a handover, a change in an identity of the MUSIM UE, and a change in RRC state of the MUSIM UE, according to the embodiments as disclosed herein;

FIG. 12 illustrates the configuration of a UE in a wireless communication system according to various embodiments; and

FIG. 13 illustrates the configuration of a base station in a wireless communication system according to various embodiments.

### BEST MODE FOR CARRYING OUT THE INVENTION

Accordingly, the embodiment herein is to provide a method for link management for a MUSIM UE performing coordinated gaps. The method includes establishing, by the MUSIM UE, a RRC connection with a first network apparatus. Further, the method includes detecting, by the MUSIM UE, a need to schedule activities associated with a second network apparatus. Further, the method includes determining, by the MUSIM UE, whether a switching gap or a RRC connection release or a RRC connection release with suspend configuration on the first network apparatus is required based on at least one of a MUSIM operation type and a required gap length for the activities associated with the second network apparatus. In an embodiment, the method includes sending a UE assistance information message comprising at least one requested switching gap information to the first network apparatus in response to determining that the switching gap is required, and receiving a MUSIM gap configuration comprising configured gap information from the first network apparatus. In another embodiment, the method includes sending a UE assistance information message comprising at least one requested switching gap release by a gap index to the first network apparatus in response to determining that the switching gap is not required, and receiving a MUSIM gap configuration comprising release of the switching gap with the gap index from the first network apparatus. In another embodiment, the method includes sending a UE assistance information message comprising a preferred RRC state to the first network apparatus in response to determining that the RRC connection release or the RRC connection release with suspend configuration is required, and receiving one of a RRC connection release and a RRC connection release with suspend configuration, wherein the preferred RRC state is one of an idle state, an inactive state, and a non-Connected state.

Accordingly, the embodiment herein is to provide a MUSIM UE for link management to perform coordinated gaps. The MUSIM UE includes a MUSIM coordinated gap controller communicatively coupled to a memory and a processor. Further, the MUSIM coordinated gap controller is configured to establish a RRC connection with a first network apparatus. Further, the MUSIM coordinated gap controller is configured to detect a need to schedule activities associated with a second network apparatus. Further, the MUSIM coordinated gap controller is configured to determine whether a switching gap or a RRC connection release or RRC connection release with suspend configuration on the first network apparatus is required based on at least one of a MUSIM operation type and a required gap length for the activities associated with the second network apparatus. In an embodiment, the MUSIM coordinated gap controller is configured to send a UE assistance information message comprising at least one requested switching gap information to the first network apparatus in response to determining that the switching gap is required, and receiving a MUSIM gap configuration comprising configured gap information from the first network apparatus. In another embodiment, the MUSIM coordinated gap controller is configured to send a UE assistance information message comprising at least one requested switching gap release by a gap index to the first network apparatus in response to determining that the switching gap is not required, and receiving a MUSIM gap configuration comprising release of the switching gap with the gap index from the first network apparatus. In another embodiment, the MUSIM coordinated gap controller is configured to send a UE assistance information message comprising a preferred RRC state to the first network apparatus in response to determining that the RRC connection release or RRC connection release with suspend configuration is required, and receiving one of a RRC connection release and a RRC connection release with suspend configuration, wherein the preferred RRC state is one of an idle state, an inactive state, and a non-Connected state.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### MODE FOR THE INVENTION

The present disclosure relates to a wireless communication, in general, and in particular, to the link management for MUSIM (multi-SIM) User Equipment's (UEs) performing coordinated gaps with a New Radio (NR), 5th generation Radio Access Technology (RAT), Networks. This application is based on and derives the benefit of Indian Provisional Application 202141014477 filed on 30 Mar. 2021, the contents of which are incorporated herein by reference.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The terms “MUSIM UE” and “UE” are used interchangeably in the patent disclosure.

Accordingly, the embodiment herein is to provide a method for link management for a MUSIM UE performing coordinated gaps. The method includes establishing, by the MUSIM UE, a RRC connection with a first network apparatus. Further, the method includes detecting, by the MUSIM UE, a need to schedule activities associated with a second network apparatus. Further, the method includes determining, by the MUSIM UE, whether a switching gap or a RRC connection release or RRC connection release with suspend configuration on the first network apparatus is required based on at least one of a MUSIM operation type and a required gap length for the activities associated with the second network apparatus. In an embodiment, the method includes sending a UE assistance information message comprising at least one requested switching gap information to the first network apparatus in response to determining that the switching gap is required, and receiving a MUSIM gap configuration comprising configured gap information from the first network apparatus. In another embodiment, the method includes sending a UE assistance information message comprising at least one requested switching gap release by a gap index to the first network apparatus in response to determining that the switching gap is not required, and receiving a MUSIM gap configuration comprising release of the switching gap with the gap index from the first network apparatus. In another embodiment, the method includes sending a UE assistance information message comprising a preferred RRC state to the first network apparatus in response to determining that the RRC connection release or RRC connection release with suspend configuration is required, and receiving one of a RRC connection release and a RRC connection release with suspend configuration, wherein the preferred RRC state is one of an idle state, an inactive state, and a non-Connected state.

The proposed method provides a scenario of how to perform actions regarding managing of different protocol/link/configuration parameters during coordinated gaps for MUSIM as introduced in NR REL-17, ensuring reliable, efficient and robust MUSIM operation.

The principal object of the embodiments herein is to provide a method and a MUSIM UE for link management for the MUSIM UE performing coordinated gaps.

Another object of the embodiments herein is to perform coordinated gaps with network and network switching for the MUSIM UE.

Another object of the embodiments herein is to determine switching gap or RRC connection release or RRC connection release with suspend configuration during a MUSIM operation.

Another object of the embodiments herein is to provide a HARQ buffers and timers' operation during switching gap.

Another object of the embodiments herein is to provide an Intermittent Measurement, CSI feedback and beam failure detection during switching gap.

Another object of the embodiments herein is to provide a SCell or a SCG activation/deactivation/release to support concurrent MUSIM operation.

In general, due to popularity of a multi-Subscriber Identity Module User Equipment's (MUSIM UEs) that host more than one Subscriber Identity Module (SIM) to have the facility to connect to two or more different networks in order to avail different data plans, have user profiles like home and office, increased connectivity/reliability with multiple connections etc. In order to save on the cost, radio frequency (RF) circuitry used by the UE is common for multiple SIMs. That implies multiple SIMs needs to arbitrate and share the common RF resource among them to perform their activities and/or avail services. Effectively, only one SIM and its associated protocol stack can be served.

Meanwhile, all other SIMs and their associated protocol stacks will be waiting for the RF resource to be available for them. One or more of the multiple SIMs can be engaged in paging reception, system information block (SIB) acquisition, measurement, data or voice call, Multimedia broadcast multicast service (MBMS) or multicast broadcast services (MBS), emergency call, access stratum (AS) signalling, Non-access stratum (NAS) signalling and so on. Some of these operations are periodic like paging and some are aperiodic and/or un-deterministic like signalling. Further, duration required to complete the operation may also be fixed or unpredictable.

Without the loss of generality, the UE would further consider two SIMs (SIM A and SIM B) associated to two different networks, say, first network apparatus and the second network apparatus respectively for the discussion. In order to share the resources among dual SIMs when they are engaged in different activities, there is a need for mechanism which creates “coordinated gaps” for one SIM (associated with first network apparatus) and make RF resource available to other SIM (associated with the second network apparatus) for the gap duration.

Short-time switching gap operation: In some situations, when gap durations are short and can be estimated or predicted, SIM A can undertake short time switching gap and remains to be in connected state with maintaining the ongoing services. Meanwhile, during short time switching gap, SIM B can pursue the desired operations and post gap, the RF control returns to the SIM A. As SIM A can inform the first network about the short timer switching gap before undertaking the gap, the network can also conserve the transmission resources and utilize same for scheduling of the other UEs. The short-time switching gap approach may also be referred to as switching without leaving a RRC_CONNECTED state on the first network apparatus.

Long-time switching gap operation: In other situations, there may be longer gaps needed when second SIM needs to pursue longer or un-deterministic operations. During this time, SIM A needs to undertake long time switching gaps and SIM B can perform the desired longer operations. The long-time switching gaps duration may also be not known or predictable in advance. Further, due to longer gaps there is drastic impact on the ongoing services on the SIM A, if there is any. As it may not be advantageous to keep the SIM A in connected mode while pursuing long timer switching gaps, UE may be switched to Idle or Inactive state. The long-time switching gap approach may also be referred to as switching with leaving a RRC_CONNECTED state on the first network apparatus.

However, it is yet not clear what gap duration is considered as a short-time switching gap (i.e. switching without leaving RRC_CONNECTED state on the first network apparatus) or long-time switching gap (i.e. switching with leaving RRC_CONNECTED state on first network apparatus) and how it is determined and/or configured. The long-time switching gap is same as RRC Release to IDLE state or RRC Release with suspend configuration to INACTIVE state by the UE on the first network apparatus.

At present 3GPP NR REL-17 MUSIM work item is studying different aspects for MUSIM operation. However, it is not yet considered as to how to manage different configuration parameters, states, buffers, timers and other protocol and/or link related aspects during the coordinated gaps are being undertaken by the relevant protocol stack or SIM (say, pertaining to the first network apparatus).

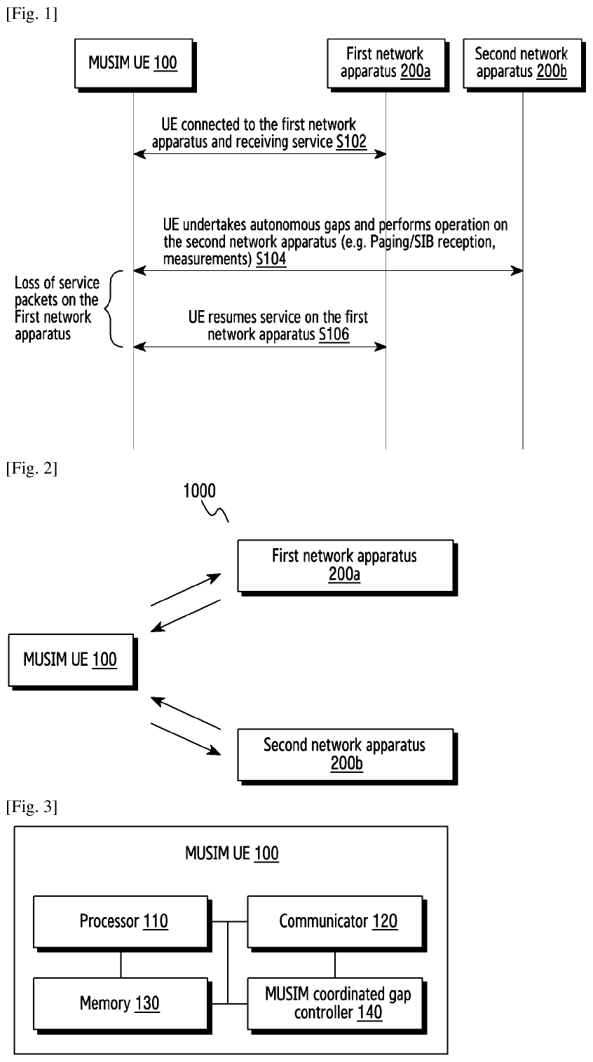

FIG. 1 is a sequence diagram illustrating link management for the MUSIM UE performing coordinated gaps, according to prior art;

At S102, the MUSIM UE (100) is connected to the first network apparatus (200a) and receives the service. At S104, the MUSIM UE (100) undertakes autonomous gaps and performs operation (e.g., Paging/SIB reception, measurements) on the second network apparatus (200b). At S106, the MUSIM UE (100) resumes service on the first network apparatus (200a). Hence, the MUSIM UE (100) incurs loss of service packets on the first network apparatus (200a) during the autonomous gaps for performing MUSIM operations.

Thus, it is desired to address the above-mentioned disadvantages or other shortcomings or at least provide a useful alternative.

Referring now to the drawings and more particularly to FIGS. 2 through 11, where similar reference characters denote corresponding features consistently throughout the figures, there are shown preferred embodiments.

FIG. 2 illustrates an overview of a wireless network (100), according to the embodiments as disclosed herein. The wireless network (100) includes a MUSIM UE (100), a first network apparatus (200a) and a second network apparatus (200b). The wireless network (1000) can be, for example, but not limited to a 5th generation (5G) wireless network, 4G network, 6G network, an ORAN or the like. The MUSIM UE (100) can be, for example, but not limited to a laptop, a desktop computer, a notebook, a relay device, a Device-to-Device (D2D) device, a vehicle to everything (V2X) device, a television, a smartphone, a tablet, an immersive device, and an internet of things (IoT) device.

In case of the MUSIM, it is not clear yet for which cases or activities the MUSIM UE (100) would need to perform short-time or long-time switching gap operation, what could be maximum duration for short-time switching gap, how the different protocol and link timers be managed, how should the HARQ buffer/process be handled during gap, whether or how measurements and/or CSI and/or BFD operation can be performed during gap etc. There may be cases in which the MUSIM UE (100) may suffer undesirable consequences if clear approach is not provided to handle MUSIM gap e.g.
a) MUSIM UE (100) may switch to other Bandwidth Part (BWP) (e.g., default BWP) due to certain timer expiry during gap and will face a loss of data or data-rate.
b) MUSIM UE (100) may clear the HARQ buffer at MUSIM gap and suffer data loss or MUSIM UE (100) may not clear HARQ buffer and face some ambiguity while combining data across the gap.

The proposed method introduces a rule in the standards defining that how the MUSIM UE (100) can determine whether it shall perform short-time switching gap operation or long-time switching gap operation (i.e. leaving RRC_CONNECTED state on the first network apparatus (200a)), including one or more of the following as:
a) Specify in the standards a list of the MUSIM activities for which the MUSIM UE (100) shall perform short-time switching gap operation and/or a list of the MUSIM activities for which the MUSIM UE (100) shall perform long-time switching gap operation. The MUSIM activities can be, for example, but not limited to
i) a Periodic switching, including SSB detection/paging reception, serving cell measurement, neighbouring cell measurement including intra-frequency, inter-frequency and inter-RAT measurement;
ii) SI receiving at the second network apparatus; and
iii) an Aperiodic (one-shot) switching with both the transmission and reception at the second network apparatus (200b) but will not enter RRC_CONNECTED state in the second network apparatus (200b) (e.g. no RRC connection Resume/Setup at second network apparatus), including On-demand SI request.
b) Specify in the standards a gap duration threshold value (or a range of gap duration values) based on which the MUSIM UE (100) shall perform short-time switching gap operation and/or long-time switching gap operation (e.g., actual MUSIM gap duration<gap duration threshold value: MUSIM UE (100) performs short-time switching gap operation; otherwise, the MUSIM UE (100) performs long-time switching gap operation). In an example, at least the following Measurement Gap Length (MGL)/Measurement Gap Repetition Period (MGRP) values are applicable for MUSIM periodic gap: MGL: 3 ms, 4 ms, 6 ms, 10 ms, 20 ms; MGRP: 20 ms, 40 ms, 80 ms, 160 ms, 320 ms, 640 ms, 1280 ms, 2560 ms, 5120 ms. In another example, at least the following MGL values are applicable for MUSIM aperiodic gap, MGL: 3 ms, 4 ms, 6 ms, 10 ms, and 20 ms. The gap duration threshold value can be the maximum specified or configured MGL.
c) The UE (100) determines to perform short-time switching gap operation and/or long-time switching gap operation on the basis dataInactivityTimer value (e.g., actual MUSIM gap duration<dataInactivityTimer value: MUSIM UE (100) performs short-time switching gap operation; otherwise, the MUSIM UE (100) performs long-time switching gap operation i.e., leaving RRC_CONNECTED state on the first network apparatus (200a)).

Further, the proposed method introduces a field in configuration or control signalling based on which the MUSIM UE (100) can determine whether it shall perform short-time switching gap operation and/or long-time switching gap operation (i.e. leaving RRC_CONNECTED state on the first network apparatus (200a)).
I. The MUSIM activity or a list of MUSIM activities (i.e., activity on other SIM) for which the MUSIM UE (100) shall perform short-time switching gap operation.
II. The MUSIM activity or a list of MUSIM activities (i.e., activity on other SIM) for which the MUSIM UE (100) shall perform long-time switching gap operation.
III. A gap duration threshold value (or a range of gap duration values) based on which MUSIM UE (100) shall perform short-time switching gap operation and/or long-time switching gap operation (e.g., actual MUSIM gap duration<gap duration threshold value: MUSIM UE (100) performs short-time switching gap operation; otherwise, the MUSIM UE (100) performs long-time switching gap operation). Alternatively, the gap duration threshold value can be the maximum specified or configured MGL.
IV. dataInactivityTimer value configured is used for gap duration threshold field purpose.
V. An explicit indication for which type of switching gap to perform for the next MUSIM activity.

In an embodiment, an example of MUSIM gap configuration is provided as follows:

MUSIM-GapConfig-r17 ::= SEQUENCE {
musim-GapToReleaseList-r17 SEQUENCE (SIZE (1..2)) OF MUSIM-GapID-r17
OPTIONAL,
musim-GapToAddModList-r17 SEQUENCE (SIZE (1..2)) OF MUSIM-GapInfo-
r17 OPTIONAL,
musim-AperiodicGap-r17 MUSIM-GapInfo-r17
OPTIONAL, -- Need N
...
}
MUSIM-GapInfo-r17 ::= SEQUENCE {
musim-GapID-r17 MUSIM-GapID-r17
OPTIONAL, -- Cond periodic
musim-Starting-SFN-AndSubframe-r17 MUSIM-Starting-SFN-AndSubframe-r17
OPTIONAL, -- Cond aperiodic
musim-GapLength-r17 ENUMERATED {ms3, ms4, ms6, ms10,
ms20} OPTIONAL,
musim-GapRepetitionAndOffset-r17 CHOICE {
ms20-r17 INTEGER (0..19),
ms40-r17 INTEGER (0..39),
ms80-r17 INTEGER (0..79),
ms160-r17 INTEGER (0..159),
ms320-r17 INTEGER (0..319),
ms640-r17 INTEGER (0..639),
ms1280-r17 INTEGER (0..1279),
ms2560-r17 INTEGER (0..2559),
ms5120-r17 INTEGER (0..5119),
...
} OPTIONAL -- Cond periodic
}
MUSIM-Starting-SFN-AndSubframe-r17 ::= SEQUENCE {
starting-SFN-r17 INTEGER (0..1023),
startingSubframe-r17 INTEGER (0..9)
}

Further, gap duration threshold value may be absolute time value (e.g., given in ms units) or may correspond to BWP/Sub-Carrier Spacing (SCS) on which it is configured (e.g., given as number of slots) i.e., on change of BWP/SCS, this value is appropriately modified for usage.

In an embodiment, gap configurations are provided per BWP. On BWP switch, specific BWP related gap configuration is applied. In another embodiment, when BWP is switched, MUSIM UE (100) applies autonomous actions to adapt the gap configuration (e.g., X slots) to the new BWP settings. In an example, when BWP1 with SCS 15 KHz is switched to BWP2 with SCS 30 KHz, gap configuration for BWP1 is scaled by 2 for getting gap configuration for BWP2 (i.e., gap becomes 2X slots).

Further, gap duration threshold value may be a maximum value for short-time switching gap. The range of gap duration values may be as a possible set of values of short-time switching gaps among which the MUSIM UE (100) can choose for different MUSIM activities (e.g., paging reception, SIB acquisition etc.).

Followings are the options for providing the MUSIM gap configuration or control signalling:
a) Radio Resource Control (RRC) signalling (e.g., RRC reconfiguration message including musim-GapConfig for setup and/or release of MUSIM gaps, RRC Release, RRC Release with Suspend Config),
b) Medium Access Control (MAC) signalling (e.g., MAC control element, MAC CE), and
c) Non-Access Stratum (NAS) signalling.

The proposed method introduces a field in control signalling or switching notification (e.g., a field “GapType”) through which the MUSIM UE (100) requests to the network whether it shall perform short-time switching gap operation or long-time switching gap operation. Options for providing the indication in control signalling or switching notification include the following:
a) RRC signalling (e.g., UE assistance information carrying MUSIM-assistance),
b) MAC signalling (e.g., MAC control element, MAC CE),
c) NAS signalling.

Further, an implicit indication of Gaptype can be provided by utilizing different signalling or switching notification mechanism for different switching types e.g., NAS signalling or the UE assistance information for long-time switching gap operation and MAC CE for short-time switching gap operation.

Further, MUSIM UE (100) may indicate (expected) gap duration in the signalling or switching notification or request message. Based on gap duration indicated, the second network apparatus determines the request is for short-time switching gap or long-time switching gap. In an embodiment, gap duration can be “unknown” also e.g., when gap duration is in-deterministic or un-predictable. Network may configure long-time switching gap and/or release the UE to Idle or Inactive state in response to “unknown” gap duration indicated.

Further, control signalling or switching notification can, on basis of explicit or implicit GapType, additionally, include one or more of the following:
a) Preferred RRC state can be one of Idle or Inactive state or a non-Connected state (i.e. Idle or Inactive or outOfConnected)
b) Preference to maintain RRC connection during gap/preference to release RRC connection during gap,
c) Duration of the gap,
d) Start time/occasion of the gap,
e) Gap pattern,
f) MUSIM activity,
g) Priority of MUSIM activity,
h) Preference for short-time or long-time switching gap,
i) Activation or deactivation or modification of gap,
j) GAP configuration identity or GAP identity,
k) Reason for Activation or deactivation or modification of gap (e.g., paging configuration change on the second network apparatus (100b))

In an embodiment, an example of UE assistance information for the MUSIM is provided as follows:

| UEAssistanceInformation-v17xy-IEs ::= SEQUENCE { | |
|---|---|
| musim-Assistance-r17 MUSIM-Assistance-r17 | |
| OPTIONAL, | |
| nonCriticalExtension SEQUENCE { } OPTIONAL | |
| } | |
| MUSIM-Assistance-r17 ::= SEQUENCE { | |
| musim-PreferredRRC-State-r17 ENUMERATED {IDLE, INACTIVE, | |
| outOfConnected} OPTIONAL, | |
| musim-GapPreferenceList-r17 MUSIM-GapPreferenceList-r17 | |
| OPTIONAL, | |
| ... | |
| } | |
| MUSIM-GapPreferenceList-r17 ::= SEQUENCE (SIZE (1..3)) OF MUSIM-GapInfo-r17 | |
| MUSIM-GapInfo-r17 ::= SEQUENCE { | |
| musim-Starting-SFN-AndSubframe-r17 MUSIM-Starting-SFN-AndSubframe-r17 | |
| OPTIONAL, | |
| musim-GapLength-r17 ENUMERATED {ms3, ms4, ms6, ms10, | |
| ms20}, | |
| musim-GapRepetitionAndOffset-r17 | CHOICE { |
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |

...
} OPTIONAL
}
MUSIM-Starting-SFN-AndSubframe-r17 ::= SEQUENCE {
starting-SFN-r17 INTEGER (0..1023),
startingSubframe-r17 INTEGER (0..9)
}

In an embodiment, MUSIM UE (100) sends gap configuration request or switching related signalling for periodic gap cases once and not at all occasions. Whereas, the MUSIM UE (100) sends gap configuration request or switching related signalling for non-periodic gap cases or one-shot gaps cases at each occasion. Further, when there is a collision or conflict e.g., a configured periodic gap (e.g., short-time switching gap) is scheduled and the MUSIM UE (100) needs to apply a one-shot gap or a long-time switching gap, the MUSIM UE (100) requests or sends switching notification to the network and network may provide the required gap.

Some of the examples of one configuration/control signalling scenario and operation is as follows:
a) Network indicates in system information block (SIB) its support for MUSIM operation and/or switching gap
b) UE indicates its MUSIM-capability and/or its support for switching gap in UE capability information message. In an embodiment, two capability bits are introduced, one for support gaps and another for “leaving connected”. There is no different capability bits for periodic and aperiodic gaps. The MUSIM related capability is per UE (without FRx and xDD differentiation).
c) Network configures the MUSIM UE (100) with a RRC Reconfiguration message. RRC Reconfiguration message carries a new information element MusimgapDurationThreshold or musim-GapLength.
d) The MUSIM UE (100) determines usage of short-time switching gap operation or long-time switching gap operation for a MUSIM activity based on configured MusimgapDurationThreshold or maximum value of configured musim-GapLength.
e) Case 1:
I. The MUSIM UE (100) sends periodic switching gap request message to the network with one or more information elements as specified
II. The network configures or confirms the periodic switching gap
f) Case 2:
I. The MUSIM UE (100) sends one-shot switching gap request message to the network with one or more information elements as specified
II. The network configures or confirms the switching gap
g) Case 3:
I. The MUSIM UE (100) sends long-time switching gap request message to the network with one or more information elements as specified
II. The network releases the RRC connection and/or switch MUSIM UE (100) to Idle or Inactive state
h) Case 4:
I. The MUSIM UE (100) sends switching gap request message (to activate/deactivate or modify configured periodic gap) to the network with one or more information elements as specified
II. The network configures/activates/modifies switching gap or deactivates switching gap as per request of MUSIM UE (100).

Further, invention also implies the case wherein a combination of the above cases can be applied for the switching gap by the MUSIM UE (100) and/or network.

In an embodiment, it is proposed that when the MUSIM UE (100) does not prefer any switching gap or UE prefers only short-time switching gap (i.e. without leaving RRC_CONENCTED state on the first network apparatus (200a)) when it is engaged in certain service on the first network apparatus (200a) (e.g., low or high priority unicast and/or MBS multicast/broadcast services), accordingly, the MUSIM UE (100) indicates to network apparatus to release/deactivate switching gap or provide switching gap. This can be signalled or requested to the network by utilising RRC signalling (e.g., UE assistance information message, MAC signalling (e.g., MAC Control Element) and/or NAS signalling. The MUSIM UE (100) may indicate the preferred switching gap (e.g., short-time switching gap, no switching gap). The MUSIM UE (100) may also request for overriding previous configuration e.g., replace previous configuration short-time switching gap configuration by no switching gap and so on. Effectively, Network configures and controls switching gaps, however, MUSIM UE (100) is provided with a method and approach to autonomously change/modify the same. In an embodiment, these actions may be a request to the network and network can choose to apply or not. In an embodiment, if the UEAssistanceInformation does not include a field for aperiodic or periodic gap preference, it indicates no preference for the corresponding field for aperiodic or periodic gap. In another embodiment, Each MUSIM gap configured by the first network apparatus (200a) is associated with an index, the MUSIM UE (100) can indicate which MUSIM gap should be released by including the corresponding MUSIM gap index into UEAssistanceInformation Message

In an embodiment, the MUSIM UE (100) may also apply autonomous gaps, wherein network is not informed, however, the MUSIM UE (100) ensures the performance on both the networks are ensured at least at defined performance level e.g., a specific paging success rate, a specific ACK/NACK performance level or a specific limited data loss etc.

The proposed method provides a rule in the standards defining that the MUSIM UE (100) shall manage which timers upon initiating or performing gap (e.g., short-time switching gap), including one or more of the listed timers as:
a) Tx/Rxrelated timers e.g., bwpInactivityTimer, sCellDeactivationTimer, dataInactivity Timer, drx-RetransmissionTimerDL, drx-RetransmissionTimerUL, drxHARQ-RTT-TimerDL, drx-HARQ-RTT-TimerUL, t-PollRetransmit, IbtFailureDetectionTimer, cg-RetransmissionTimer, configuredGrantTimer,
b) QoSrelated timers e.g., t-reordering, t-reassembly, DiscardTimer, t-StatusProhibit, and
c) Mobilityrelated timers e.g., timeAlignmentTimer, beamFailureDetectionTimer, beamFailureRecovery Timer

Further, above options represents the one possible grouping or classifications of timers, without any restriction implied.

The proposed method introduces a rule in the standard defining that the MUSIM UE (100) shall perform which actions for timers upon initiating or performing gap (e.g., short-time switching gap), including one or more of the listed actions as:
a) Stop the timer at beginning of the gap and start/restart the timer at the end of the gap. (Further, this also includes to stop the timer at beginning of the gap and resume the timer from previous timer value at the end of the gap)
b) Continue to run the timer (i.e., timer is not stopped during gap). If timer is expired during the gap, any resultant action is held until gap end and is performed at the first relevant opportunity after the gap end. Timer may be started/restarted after the gap end.
c) Continue to run the timer (i.e., timer is not stopped at beginning of gap). Timer value is extended by adding to it the gap duration so that timer is not expired during gap and effectively, gap has no impact on timer.
d) Continue to run the timer (i.e., timer is not stopped at beginning of gap). If timer is expired during the gap, no resultant action is performed. That is, unlike traditional behaviour for timer, in this scenario the MUSIM UE (100) does not perform any action related to timer expiry during gap or at end of gap.

Introduce a field or a set of fields in configuration or control signalling based on which the MUSIM UE (100) can determine whether it shall perform which actions for timers upon initiating or performing gap (e.g., short-time switching gap), including one or more of the listed actions as specified.

Further, a field or a set of fields can be specified for each timer or a group/classification of timers (e.g., one possible grouping or classification of timers as specified).

Some of the specific examples are as follows:
1. bwpInactivityTimerexpiry during gap would cause BWP switching to initial BWP or default BWP which is undesirable as MUSIM UE (100) intends to continue operation on same active BWP after the gap. Therefore, solution based on a), c) and/or d) as specified can be utilized.
2. discardTimer is related to service QoS performance, hence solution based on b) can be utilized to ensure QoS performance criteria is unaffected due to MUSIM gap.
3. dataInactivityTimer expiry during gap would cause MUSIM UE (100) to release RRC connection and switch to Idle state. Therefore, solution based on a), c) and/or d) as specified can be utilized.
4. timeAlignmentTimer is related to mobility and time synchronization tracking, therefore it needs to be continued through the gap. Therefore, solution based on b) as specified can be utilized.
5. A generic operation for the timers handling can be provided based on classification/grouping of timers:
a. Tx/Rx related timers: Timers are stopped, as the expiry due to lack of scheduling availability would make Tx/Rx operation not work. The MUSIM UE (100) may have some abnormal situation that for instance MUSIM UE (100) switches to the default BWP.
b. QoS related timers: Timers are not stopped to meet the QoS performance constraints
c. Mobility related timers: Timers are not stopped in order to ensure link is maintained and sustained

The proposed method introduces a rule in the standard defining that how the MUSIM UE (100) shall handle HARQ buffer(s)/process(es) upon initiating or performing gap (e.g., short-time switching gap), including one or more of the listed approaches as—
a) HARQ buffer/process is cleared when the MUSIM UE (100) undertakes MUSIM gap operation,
b) HARQ buffer/process is not cleared when the MUSIM UE (100) undertakes MUSIM gap operation,
c) HARQ buffer/process and/or associated operation is suspended at start of gap and is resumed at end of the gap, and
d) HARQ buffer/process is cleared conditionally e.g., gap duration>=t-reordering value and/or gap duration>=discardTimervalue and/or gap duration>=a specified or configured threshold value (e.g. maximum value of configured musim-GapLength)

The proposed method introduces a field in configuration or control signalling based on which the MUSIM UE (100) can determine threshold value for gap duration for handling HARQ buffer(s)/process(es) upon initiating or performing gap (e.g., short-time switching gap), including action as specified.

Some of the examples are as follows—
a) In an example, when HARQ buffer is shared across two protocols stacks or SIMs, then as per solution and HARQ buffer/process is cleared
b) In another example, when HARQ buffer/process is not shared across two protocols stacks or SIMs, then solution mentioned above can be utilized to avoid any data loss
I. In another example, Network configures a gap threshold value in the RRC reconfiguration message for the MUSIM UE (100).
II. In another example, When the MUSIM UE (100) is configured and/or undertakes short-time switching gap (i.e., without leaving RRC_CONNECTED state on first network apparatus (200a)), the MUSIM UE (100) compares the actual MUSIM gap duration with configured gap threshold.
III. In another example, The MUSIM UE (100) clears/flushes HARQ buffer and/or reset HARQ process, when gap duration>=configured gap threshold value (e.g. maximum value of configured musim-GapLength).
IV. In another example, The MUSIM UE (100) does not clear/flush HARQ buffer and/or does not reset HARQ process, when gap duration<configured gap threshold value
V. In another example, When the UE (100) is configured for long time switching (e.g., through RRC reconfiguration or RRC Release or RRC Release with suspend configuration or NAS signalling) and/or undertakes long-time switching gap (i.e. leaving RRC_CONNECTED state on the first network apparatus (200a)), the MUSIM UE (100) clears/flushes HARQ buffer(s) and/or reset HARQ process(es).

Measurement handling introduce a rule in the standard defining that the MUSIM UE (100) shall perform which actions for measurements/CSI operations upon initiating or performing gap (e.g., short-time switching gap), including one or more of the listed actions as—
a) UE discards the measurement request received or configured by the network for which the measurement resources lie partially or fully in the switching gap period or for which measurement report cannot be transmitted prior to the start of the gap
b) UE performs intermittent Rx operation during gap and performs measurements in accordance with measurement resources as configured by the network. Measurement operation may be performed by same Rx (e.g., Rx time-sharing or in accordance with suitable gap pattern) or by utilizing additional Rx capability of the UE
c) UE reports the measurement results or CSI feedback to the network by performing intermittent Tx operation during gap in accordance with the reporting configuration provided by the network. Reporting operation may be performed by same Tx (e.g., Tx time-sharing, Tx time slicing or in accordance with suitable gap pattern) or by utilizing additional Tx capability of the UE (100).

Further, the measurement handling introduces a rule in the standard defining that how the MUSIM UE (100) shall handle measurements/CSI operation which includes the following—
a) Radio Resource Management measurements (e.g., SSB or CSIRS based L3 mobility measurements),
b) Beam measurements,
c) L1 RSRP measurements,
d) Positioning measurements,
c) SFN and Frame Timing Difference (SFTD) measurements,
f) Radio Link Monitoring (RLM),
g) Measurement reporting, and
h) CSI feedback reporting (including CQI, PMI, RI etc.).

Further, network ensures availability of measurement resources in the intermittent occasion (in accordance with the gap pattern) and/or during the entire gap duration and/or common measurement resources are utilized e.g., SSB.

Further, the gap pattern in accordance with the measurement resources configuration/availability is prepared by the UE (conveyed to network in the UE assistance information message) and confirmed/configured by network for the MUSIM UE (100) (by RRC reconfiguration message). Alternatively, the network prepares a suitable gap pattern in accordance with the measurement resources configuration/availability and configure for the MUSIM UE (100) through RRC reconfiguration message. Gap configuration includes at least one of the following:
a) Gap start/offset,
b) Gap length/duration,
c) GAP pattern e.g., repetition pattern, and
d) GAP configuration identity or GAP identity.

Support for intermittent measurements during MUSIM gap is indicated by network in configuration message (e.g., RRC reconfiguration messaged) and/or support for measurement capability during MUSIM gap is informed to the network by the UE capability and/or the UE assistance information message.

Introduce a field or a set of fields in configuration or control signalling based on which the MUSIM UE (100) can determine whether it shall perform which actions for measurements/CSI operations upon initiating or performing gap (e.g., short-time switching gap), including one or more of the actions as described earlier.

Some of the examples are as follows:
a) The MUSIM UE (100) and/or network configure the MUSIM gap pattern in accordance with the measurement configuration. The UE, therefore, performs measurement operations during intermittent occasions for MUSIM gap.
b) The MUSIM UE (100) performs measurement operations during intermittent occasions for MUSIM gap (as per measurement configurations) by utilizing additional Rx capability.

Further, for the beam failure determination and recovery, invention introduces a rule in the standard defining that the MUSIM UE (100) shall perform which actions for beam failure detection (BFD) and beam failure recovery operations upon initiating or performing gap (e.g., short-time switching gap i.e. without leaving RRC_CONNECTED state in the first network apparatus (200a)), including one or more of the listed actions as—
a) UE stops BFD timer and/or suspends monitoring/detection for beam failure at beginning of gap. The MUSIM UE (100) sets BFI counter to 0.
b) The MUSIM UE (100) starts/restarts BFD timer and/or resumes monitoring/detection for beam failure at end of gap. The MUSIM UE (100) may set BFI counter to 0.
c) The MUSIM UE (100) continues running BFD timer and/or continues monitoring/detection for beam failure during the gap. If beam failure instance is detected more than a threshold, the MUSIM UE (100) initiates beam recovery procedure immediately if this is SCell or initiate random access immediately if this is spCell. Alternately, the UE holds beam recovery procedure and/or random access and performs only at the end of the gap.
d) The MUSIM UE (100) continues running BFD timer and/or does not perform monitoring/detection for beam failure during the gap. If BFD timer expires during gap, the MUSIM UE (100) ignores this.

BFD operations on the first network apparatus (200a) when the MUSIM UE (100) is configured with MUSIM gaps. Further, the MUSIM UE (100) may perform beam failure detection intermittently during the switching gap (in accordance with the gap pattern) utilizing common reference signal like SSB or the MUSIM UE (100) dedicated reference signal like CSIRS. Also, beam failure detection operation can be performed during switching gap by utilizing additional Rx capability of the MUSIM UE (100).

Introduce a field or a set of fields in configuration or control signalling based on which the MUSIM UE (100) can determine whether it shall perform which actions for beam failure detection (BFD) and beam failure recovery operations upon initiating or performing gap (e.g., short-time switching gap i.e. without leaving RRC_CONNECTED state in the first network apparatus (200a)), including one or more of the actions as described earlier.

Below are some specific examples:
a) In an example, MUSIM UE (100) performs no BFD operation during MUSIM gap. UE stops BFD timer during MUSIM gap
b) In another example, Network configures MUSIM UE (100) with requested gap pattern or the network apparatus assign gap pattern allowing intermitted BFD operation. BFD resources are provided by the network apparatus and MUSIM UE (100) utilizes these resources or SSB resources to perform BFD. If beam failure is detected, the MUSIM UE (100) performs the recovery at the end of the MUSIM gap. Further, the MUSIM UE (100) may limit the candidate beams for recovery post MUSIM gap to quickly perform the beam recovery operation.
c) In another example, BFI counter is preserved during MUSIM gap. Otherwise, BFD timer expiry would reset BFI counter and delay the BFR

```
  The MAC entity shall for each Serving Cell configured for beam failure detection:
1> if beam failure instance indication has been received from lower layers:
        2> start or restart the beamFailureDetectionTimer;
        2> increment BFI_COUNTER by 1;
        2> if BFI_COUNTER>= beamFailureInstanceMaxCount:
        3> if the Serving Cell is SCell:
            4> trigger a BFR for this Serving Cell;
        3> else:
            4>initiate a Random Access procedure (see clause 5.1) on the SpCell.
1> if the beamFailureDetectionTimer expires and UE is not within MUSIM GAP; or
1> if beamFailureDetectionTimer, beamFailureInstanceMaxCount, or any of the
  reference signals used for beam failure detection is reconfigured by upper layers
  associated with this Serving Cell:
        2> set BFI_COUNTER to 0.
1> if the Serving Cell is SpCell and the Random Access procedure initiated for SpCell
beam failure recovery is successfully completed:
        2> set BFI_COUNTER to 0;
        2> stop the beamFailureRecoveryTimer, if configured;
        2> consider the Beam Failure Recovery procedure successfully completed.
1> else if the Serving Cell is SCell, and a PDCCH addressed to C-RNTI indicating
uplink grant for a new transmission is received for the HARQ process used for the
transmission of the BFR MAC CE or Truncated BFR MAC CE which contains beam
failure recovery information of this Serving Cell; or
1> if the SCell is deactivated:
        2> set BFI_COUNTER to 0;
        2> consider the Beam Failure Recovery procedure successfully completed and
        cancel all the triggered BFRs for this Serving Cell.
```

In an embodiment, the MUSIM UE (100) requests for SCell or SCG deactivation on SIM A (associated with the first network apparatus (200a)) in order to support MUSIM activity on SIM B (associated with the second network apparatus (200b)) e.g., when the MUSIM UE (100) is engaged in MRDC (Multi-RAT Dual Connectivity). The MUSIM UE (100) may determine the SCell or the SCG deactivation or activation or release based on data rate, priority of services, data inactivity, power saving needs for SIM A as against the preference, priority of MUSIM activity on the SIM B and/or change in UE resource or processing capability. The MUSIM UE (100) sends a SCell or a SCG deactivation request by utilizing at least one of RRC signalling (e.g., UE assistance information message), Uplink Control Indication signalling and MAC signalling (e.g., MAC Control Element). The MUSIM UE (100) receives responses from network (e.g., deactivation of SCell or SCG through RRC signalling or DCI (Downlink Control Indication) or MAC Control element). Further, when MUSIM activity is completed and/or MUSIM UE (100) has higher priority or more data rate activity on the first network apparatus (200a) or UE resource or processing capability is restored or UE removes/releases second SIM/Network, UE can activate and/or reactivate or deactivate or release SCell or SCG for the SIM A (associated with the first network apparatus (200a)). The signalling approach can be similar to that described for deactivation.

Furthermore, the proposed method introduces a rule in the standard defining that the UE shall perform which actions upon initiating or performing gap, including one or more of the listed actions as—
a) MUSIM UE (100) performs RLC retransmission, which is due because of NACK received before the gap, at the first opportunity after the gap end
b) MUSIM UE (100) performs RLC status transmission, which is due to t-statusProhibit expiry before the gap or due to t-statusProhibit expiry during gap, at the first opportunity after the gap end
c) MUSIM UE (100) suspends Scheduling Request (SR) when UE undertakes gap and resumes SR post switching gap. Alternatively, UE transmits SR triggered during gap immediately at first opportunity post switching gap
d) MUSIM UE (100) suspends Random Access procedure (RA) when UE undertakes gap and resumes RA post switching gap. Alternatively, UE transmits RA triggered during gap immediately at first opportunity post switching gap
e) MUSIM UE (100) performs SI validity check, which happens to occur during the gap, post the switching gap
f) MUSIM UE (100) UE suspends PUCCH resources usage during the switching gap and resumes it post gap
g) The active BWP may be considered by MUSIM UE (100) and/or configured by Network as dormant during the switching gap i.e.

At MUSIM gap start, consider that the BWP is activated and status for the active DL
BWP for the Serving Cell is dormant BWP. UE performs the following actions:
2> stop the bwp-InactivityTimer of this Serving Cell, if running.
2> not monitor the PDCCH on the BWP;
2> not monitor the PDCCH for the BWP;
2> not receive DL-SCH on the BWP;
2> not report CSI on the BWP, report CSI except aperiodic CSI for the BWP;
2> not transmit SRS on the BWP;
2> not transmit on UL-SCH on the BWP;
2> not transmit on RACH on the BWP;
2> not transmit PUCCH on the BWP
At MUSIM gap end, consider the status for the active DL BWP for the Serving Cellis
not dormant BWP

h) PHR reporting is suspended during the switching gap and is resumed once switching gap is over.

SI validity check examples are as follows: MUSIM UE (100) applies SI acquisition procedure upon
a) cell selection (e.g., upon power on),
b) cell-reselection,
c) return from out of coverage,
d) after reconfiguration with sync completion,
e) after entering the network from another RAT,
f) upon receiving an indication that the system information has changed,
g) upon receiving a PWS notification,
h) upon receiving request (e.g., a positioning request) from upper layers; and
i) Whenever the MUSIM UE (100) does not have a valid version of a stored SIB or posSIB or a valid version of a requested SIB.

One or more of above-mentioned events (e.g., getting request from higher layer, the UE movement across during gap duration) may occur just before and/or during the switching gap, in this condition, it is specified that MUSIM UE (100) performs SI validity check after the switching gap after evaluating or determining the events/conditions.

In another embodiment, when the MUSIM UE (100) has already have periodic configured gap on the first network apparatus (200a) (e.g. for paging reception on the second network apparatus (200b)) and there is change of paging configuration on the second network apparatus (200b) e.g. due to paging configuration parameter change, due to cell reselection, change of UE identity on the second network apparatus (200b), change of RRC state e.g. between Idle and Inactive state on the second network apparatus (200b), then in these cases, UE informs the first network apparatus (200a) and/or also requests for new gap configuration and/or switching notification/request. The MUSIM UE (100) may also request to deactivate the immediate periodic gap occurring. Alternatively, the MUSIM UE (100) undertakes autonomous gaps on the first network apparatus (200a) when new paging occasion for the second network apparatus (200b) is applicable in order to not to miss paging.

In an embodiment, the UE capable of providing MUSIM assistance information may initiate the procedure if it was configured to do so, upon determining that it needs to leave RRC_CONNECTED state, or upon determining it needs the gaps, or upon change of the gap information without leaving RRC_CONNECTED state.

FIG. 3 illustrates various hardware components of the MUSIM UE (100), according to the embodiments as disclosed herein. The MUSIM UE (100) includes a processor (110), a communicator (120), a memory (130), and a MUSIM coordinated gap controller (140). The processor (110) is coupled with the communicator (120), the memory (130), and the MUSIM coordinated gap controller (140).

The MUSIM coordinated gap controller (140) is configured to establish the RRC connection with the first network apparatus (200a) and detect the need to schedule activities associated with the second network apparatus (200b). Further, the MUSIM coordinated gap controller (140) is configured to determine whether the switching gap or the RRC connection release or the RRC connection release with suspend configuration on the first network apparatus (200a) is required based on at least one of a MUSIM operation type and a required gap length for the activities associated with the second network apparatus (200b). In an embodiment, the MUSIM coordinated gap controller (140) is configured to detect at least one of the required gap length is greater than a maximum specified gap length and a MUSIM activity type is a specific MUSIM activity. Further, the MUSIM coordinated gap controller (140) is configured to determine RRC connection release or the RRC connection release with suspend configuration on the first network apparatus (200a) is required when at least one of the required gap length is greater than the maximum specified gap length and the MUSIM activity type is the specific MUSIM activity.

In an embodiment, further, the MUSIM coordinated gap controller (140) is configured to send the UE assistance information message comprising the requested switching gap information to the first network apparatus (200a) in response to determining that the switching gap is required, and receive the MUSIM gap configuration comprising configured gap information from the first network apparatus (200a). The configured gap information can be, for example, but not limited to a configured gap index, a configured gap offset, a configured gap repetition, a configured periodic gap length, a configured aperiodic gap starting System Frame Number (SFN) and starting sub-frame, and a configured aperiodic gap length. In an embodiment, the MUSIM coordinated gap controller (140) is configured to determine at least one of a periodic gap length, an aperiodic gap length, a gap index, a gap offset, and a gap repetition based on a specified gap length associated with the second network apparatus (200b). Further, the MUSIM coordinated gap controller (140) is configured to send the MUSIM UE assistance information message comprising the requested switching gap information to the first network apparatus (200a), wherein the requested switching gap information comprises at least one of the determined periodic gap length, the determined aperiodic gap starting System Frame Number (SFN) and starting sub-frame, the determined aperiodic gap length, the determined gap index, the determined gap offset, and the determined gap repetition.

In another embodiment, further, the MUSIM coordinated gap controller (140) is configured to send the UE assistance information message comprising the requested switching gap release by the gap index to the first network apparatus (200a) in response to determining that the switching gap is not required, and receive the MUSIM gap configuration comprising release of the switching gap with the gap index from the first network apparatus (200a). In an embodiment, the MUSIM coordinated gap controller (140) is configured to send the UE assistance information message to the first network apparatus (200a) when a periodic switching gap is to be released and skip sending the UE assistance information message to the first network apparatus (200a) when an aperiodic switching gap is to be released and implicitly release the aperiodic switching gap after the gap period is over for the aperiodic switching gap.

In an embodiment, further, the MUSIM coordinated gap controller (140) is configured to send the UE assistance information message comprising the preferred RRC state to the first network apparatus (200a) in response to determining that the RRC connection release or RRC connection release with suspend configuration is required, and receiving one of a RRC connection release and a RRC connection release with suspend configuration. The preferred RRC state is one of an idle state, an inactive state, and a non-Connected state.

Further, the MUSIM coordinated gap controller (140) is configured to detect whether the switching gap is initiated to perform the activities on the second network apparatus (200b). MUSIM coordinated gap controller (140) is configured to manage at least one of a Transmission (Tx)-Reception (Rx) related timer, a Quality of Service (QOS) related timer, and a mobility related timer in response to detecting the initiation of the switching gap. MUSIM coordinated gap controller (140) is configured to perform at least one action. In an embodiment, the action comprises stop at least one of the Tx-Rx related timer, the QoS related timer, and the mobility related timer at a beginning of the switching gap, and start or restart at least one of the Tx-Rx related timer, the QoS related timer, and the mobility related timer at an end of the switching gap. In another embodiment, the action comprises stop at least one of the Tx-Rx related timer, the QoS related timer, and the mobility related timer at a beginning of the switching gap, and resume at least one of the Tx-Rx related timer, the QoS related timer, and the mobility related timer from a previous timer value at an end of the switching gap. In another embodiment, the action comprises continue to run at least one of the Tx-Rx related timer, the QoS related timer, and the mobility related timer during the switching gap, hold any resultant action until the switching gap end when at least one of the Tx-Rx related timer, the QoS related timer, and the mobility timer expires during the switching gap and start or restart at least one of the Tx-Rx related timer, the QoS related timer, and the mobility related timer at an end of the switching gap. In another embodiment, the action comprises continue to run at least one of the Tx-Rx related timer, the QoS related timer, and the mobility related timer, and extend the timer value by adding the switching gap duration so that timer is not expired during the switching gap. In another embodiment, the action comprises continue to run at least one of the Tx-Rx related timer, the QoS related timer, and the mobility related timer during the switching gap, skip performing any resultant action when at least one of the Tx-Rx related timer, the QoS related timer, and the mobility timer expires during the switching gap and start or restart at least one of the Tx-Rx related timer, the QoS related timer, and the mobility related timer at an end of the switching gap.

Further, the MUSIM coordinated gap controller (140) is configured to detect an initiation of the switching gap to perform the MUSIM activities on the second network apparatus (200b). Further, the MUSIM coordinated gap controller (140) is configured to determine whether HARQ buffers are shared across two protocol stacks pertaining to two SIMs of the MUSIM UE (100). In an embodiment, the MUSIM coordinated gap controller (140) is configured to flush at least one of downlink (DL) and uplink (UL) HARQ buffers at time of the switching gap in response to determining that the HARQ buffers are shared across the two protocol stacks pertaining to the two SIMs of the MUSIM UE (100). In another embodiment, the MUSIM coordinated gap controller (140) is configured to avoid flush at least one of DL and UL HARQ buffers at time of the switching gap in response to determining that the HARQ buffers are not shared across the two protocol stacks pertaining to the two SIMs of the MUSIM UE (100).

Further, the MUSIM coordinated gap controller (140) is configured to detect an initiation of the switching gap to perform the MUSIM activities on the second network apparatus (200b). Further, the MUSIM coordinated gap controller (140) is configured to perform intermittent Rx operation and at least one of measurements and a CSI evaluation during the switching gap in accordance with resources as configured by the first network apparatus (200a). Further, the MUSIM coordinated gap controller (140) is configured to report measurement results and CSI feedback to the first network apparatus (200a) by performing intermittent Tx operation during the switching gap in accordance with the reporting configuration provided by the first network apparatus (200a).

Further, the MUSIM coordinated gap controller (140) is configured to determine a SCell or a SCG activation or deactivation or release based on at least one of a data rate, a priority of service, data inactivity, power saving requirement for a first SIM associated with the first network apparatus (200a), a priority of MUSIM activity on a second SIM associated with the second network apparatus (200b), and a change in UE capability and resources. Further, the MUSIM coordinated gap controller (140) is configured to send a SCell or a SCG activation or deactivation or release request to the first network apparatus (200a) by utilizing at least one of RRC signaling, uplink control indication (UCI) signaling, and MAC signaling. Further, the MUSIM coordinated gap controller (140) is configured to receive a SCell or a SCG activation or deactivation or release in response from the first network apparatus (200a). Further, the MUSIM coordinated gap controller (140) is configured to perform a SCell or a SCG activation or deactivation or release as received from the first network apparatus (200a). Further, the MUSIM coordinated gap controller (140) is configured to activate the deactivated SCell or SCG for the first SIM associated with the first network apparatus (200a) when at least one of a MUSIM activity is completed, the MUSIM UE has higher priority, the MUSIM UE (100) has more data rate activity on the first network apparatus (200a), resources or processing capabilities of the MUSIM UE (100) is restored, and the MUSIM UE (100) removes or releases the second SIM associated with the second network apparatus (200b).

Further, the MUSIM coordinated gap controller (140) is configured to detect an initiation of the switching gap to perform the MUSIM activities on the second network apparatus (200b). Further, the MUSIM coordinated gap controller (140) is configured to suspend at least one of a random access (RA) procedure, a scheduling request (SR) procedure, a Power Headroom Report (PHR) reporting, a System Information (SI) validation check or acquisition, and a Physical Uplink Control Channel (PUCCH) resource usage before or at the start of the switching gap. Further, the MUSIM coordinated gap controller (140) is configured to detect an end of the switching gap. Further, the MUSIM coordinated gap controller (140) is configured to resume at least one of the random access procedure, the scheduling request procedure, the PHR reporting, the SI validation check or acquisition, and the PUCCH resource usage at the end of the switching gap.

Further, the MUSIM coordinated gap controller (140) is configured to detect an initiation of the switching gap to perform the MUSIM activities on the second network apparatus (200b). Further, the MUSIM coordinated gap controller (140) is configured to detect an event on one of the first network apparatus (200a) and the second network apparatus (200b), wherein the event comprises at least one of a change of paging configuration, reselection of a cell, an occurrence of a handover, a change in an identity of the MUSIM UE, and a change in RRC state of the MUSIM UE (100). Further, the MUSIM coordinated gap controller (140) is configured to trigger a switching gap request for a new MUSIM gap configuration or a release of MUSIM gap configuration or a modification of MUSIM gap configuration.

The MUSIM coordinated gap controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. Furthermore, the operation of the MUSIM coordinated gap controller (140) described above may perform by the processor (110).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the MUSIM UE (100) but it is to be understood that other embodiments are not limited thereon. In other embodiments, the MUSIM UE (100) may include less or more number of components. Further, the labels or names of the components are used only for illustrative purpose and does not limit the scope of the invention. One or more components can be combined together to perform same or substantially similar function in the MUSIM UE (100).

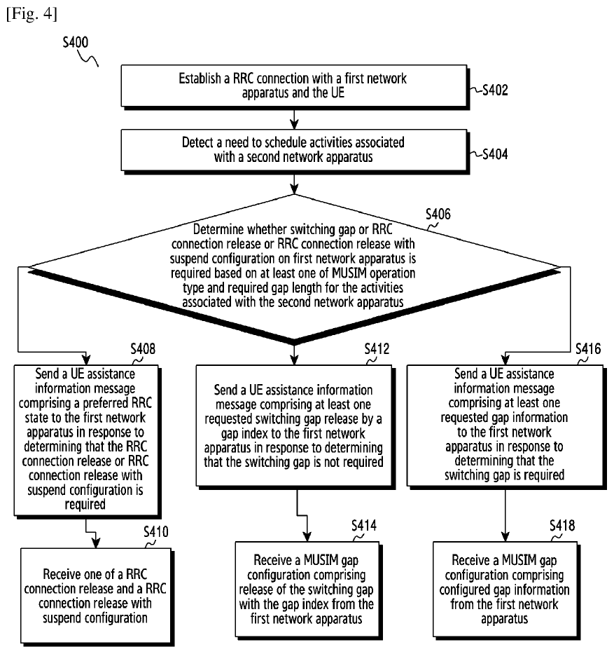

FIG. 4 is a flow chart (S400) illustrating a method for link management for the MUSIM UE (100) performing coordinated gaps, according to the embodiments as disclosed herein. The operations (S402-S418) are handled by the MUSIM coordinated gap controller (140).

At S402, the method includes establishing the RRC connection with the first network apparatus (200a) with the UE (100). At S404, the method includes detecting the need to schedule activities associated with the second network apparatus (200b). At S406, the method includes determining whether the switching gap or the RRC connection release or RRC connection release with suspend configuration on the first network apparatus (200a) is required based on the MUSIM operation type and the required gap length for the activities associated with the second network apparatus (200b).

At S408, the method includes sending the UE assistance information message comprising the preferred RRC state to the first network apparatus (200a) in response to determining that the RRC connection release or the RRC connection release with suspend configuration is required. At S410, the method includes receiving one of the RRC connection release and the RRC connection release with suspend configuration.

At S412, the method includes sending the UE assistance information message comprising at least one requested switching gap release by the gap index to the first network apparatus (200a) in response to determining that the switching gap is not required. At S414, the method includes receiving the MUSIM gap configuration comprising release of the switching gap with the gap index from the first network apparatus (200a).

At S416, the method includes sending the UE assistance information message comprising at least one requested switching gap information to the first network apparatus (200a) in response to determining that the switching gap is required. At S418, the method includes receiving the MUSIM gap configuration comprising configured gap information from the first network apparatus (200a).

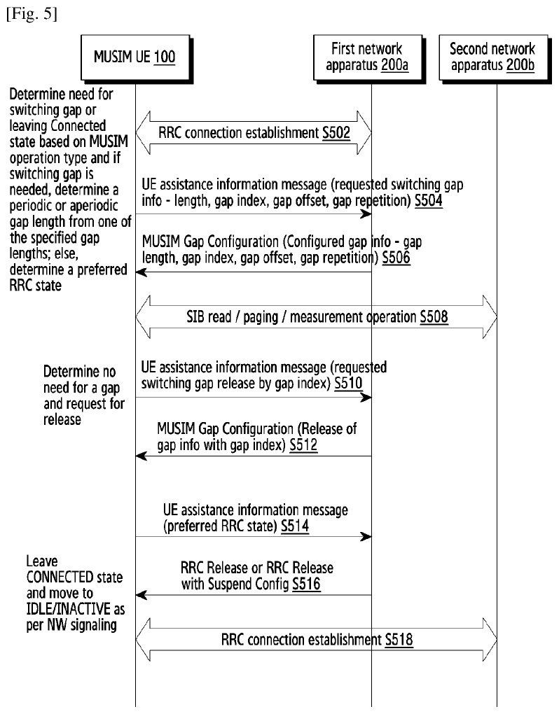

FIG. 5 is a sequence diagram illustrating a method for link management for the MUSIM UE (100) performing the coordinated gaps, according to the embodiments as disclosed herein. The MUSIM UE (100) determines the need for switching gap or leaving connected state based on MUSIM operation type and if switching gap is needed. The MUSIM UE (100) also determines the periodic or aperiodic gap length from one of the specified gap lengths or determines the preferred RRC state.

At S502, the RRC connection establishment is between the MUSIM UE (100) and the first network apparatus (200a). At S504, the MUSIM UE (100) sends the UE assistance information message (e.g., requested switching gap info—length, gap index, gap offset, gap repetition) to the first network apparatus (200a). At S506, the first network apparatus (200a) sends the MUSIM Gap Configuration (e.g., Configured gap info—gap length, gap index, gap offset, gap repetition) to the MUSIM UE (100). At S508, the SIB read operation/paging operation/measurement operation is between the MUSIM UE (100) and the second network apparatus (200b).

At S510, the MUSIM UE (100) sends the MUE assistance information message (e.g., requested switching gap release by gap index) to the first network apparatus (200a). At S512, the first network apparatus (200a) sends the MUSIM gap configuration (e.g., release of gap info with gap index) to the MUSIM UE (100).

At S514, the MUSIM UE (100) sends the UE assistance information message (e.g., preferred RRC state) to the first network apparatus (200a). At S516, the first network apparatus (200a) sends the RRC release or RRC release with suspend Config to the MUSIM UE (100). At S518, the RRC connection establishment is done between the MUSIM UE (100) and the second network apparatus (200b).

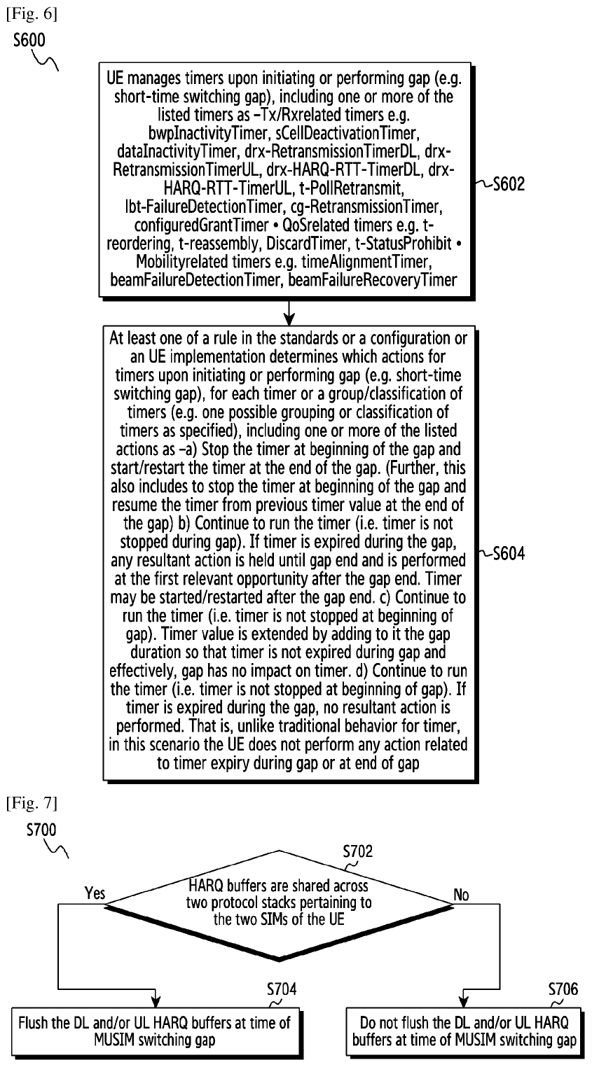

FIG. 6 is a flow chart (S600) illustrating a method for link management for the MUSIM UE (100) performing coordinated gaps based on timers, according to the embodiments as disclosed herein. The operations (S602 and S604) are handled by the MUSIM coordinated gap controller (140).

At S602, the UE (100) manages timers upon initiating or performing gap (e.g. short-time switching gap), including one or more of the listed timers as—Tx/Rxrelated timers (e.g. bwpInactivity Timer, sCellDeactivationTimer, dataInactivityTimer, drx-RetransmissionTimerDL, drx-Retransmission TimerUL, drxHARQ-RTT-TimerDL, drx-HARQ-RTT-TimerUL, t-PollRetransmit, IbtFailureDetectionTimer, cg-RetransmissionTimer, configuredGrantTimer or the like), QoSrelated timers (e.g. t-reordering, t-reassembly, DiscardTimer, t-StatusProhibit or the like) and Mobilityrelated timers (e.g. timeAlignmentTimer, beamFailureDetectionTimer, beamFailureRecovery Timer or the like).

At S604, at least one of a rule in the standards or a configuration or an UE implementation determines which actions for timers upon initiating or performing gap (e.g., short-time switching gap), for each timer or a group/classification of timers (e.g., one possible grouping or classification of timers as specified), including one or more of the listed actions as—a) Stop the timer at beginning of the gap and start/restart the timer at the end of the gap. (Further, this also includes to stop the timer at beginning of the gap and resume the timer from previous timer value at the end of the gap) b) Continue to run the timer (i.e., timer is not stopped during gap). If timer is expired during the gap, any resultant action is held until gap end and is performed at the first relevant opportunity after the gap end. Timer may be started/restarted after the gap end. c) Continue to run the timer (i.e., timer is not stopped at beginning of gap). Timer value is extended by adding to it the gap duration so that timer is not expired during gap and effectively, gap has no impact on timer. d) Continue to run the timer (i.e., timer is not stopped at beginning of gap). If timer is expired during the gap, no resultant action is performed. That is, unlike traditional behavior for timer, in this scenario the MUSIM UE (100) does not perform any action related to timer expiry during gap or at end of gap.

FIG. 7 is a flow chart (S700) illustrating a method for link management for the MUSIM UE (100) performing coordinated gaps based on whether HARQ buffers are shared across two protocol stacks pertaining to two SIMs of the MUSIM UE (100), according to the embodiments as disclosed herein. The operations (S702-S706) are handled by the MUSIM coordinated gap controller (140). At S702, the MUSIM UE (100) determines whether the HARQ buffers are shared across two protocol stacks pertaining to the two SIMs of the UE (100). If the HARQ buffers are shared across two protocol stacks pertaining to the two SIMs of the UE (100) then, at S704, the MUSIM UE (100) flushes the DL and/or UL HARQ buffers at time of MUSIM switching gap. If the HARQ buffers are not shared across two protocol stacks pertaining to the two SIMs of the UE (100) then, at S706, the MUSIM UE (100) does not flush the DL and/or UL HARQ buffers at time of MUSIM switching gap.

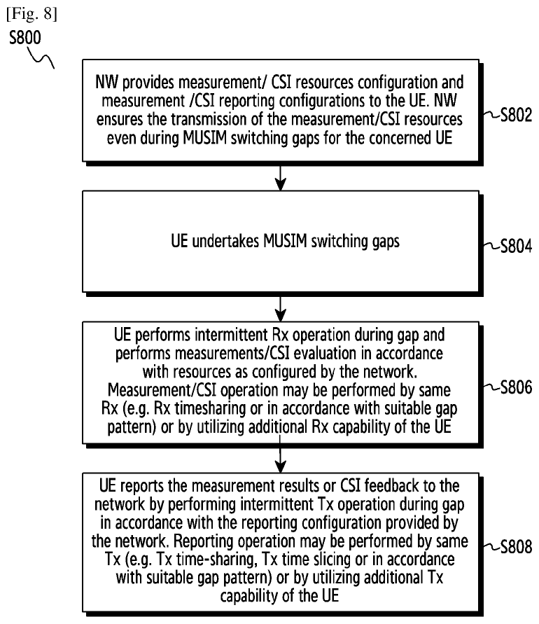

FIG. 8 is a flow chart (S808) illustrating a method for link management for the MUSIM UE (100) performing coordinated gaps based on intermittent Rx operation and measurements and the CSI evaluation during the switching gap in accordance with resources as configured by the first network apparatus, according to the embodiments as disclosed herein. The operations (S802-S808) are handled by the MUSIM coordinated gap controller (140).

At S802, the first network apparatus (200a) provides the measurement/CSI resources configuration and measurement/CSI reporting configurations to the UE (100). The first network apparatus (200a) ensures the transmission of the measurement/CSI resources even during MUSIM switching gaps for the concerned UE (100). At S804, the UE (100) undertakes MUSIM switching gaps. At S806, the UE (100) performs intermittent Rx operation during gap and performs measurements/CSI evaluation in accordance with resources as configured by the first network apparatus (200a). The measurement/CSI operation may be performed by same Rx (e.g., Rx timesharing or in accordance with suitable gap pattern) or by utilizing additional Rx capability of the UE (100). At S808, the UE (100) reports the measurement results or CSI feedback to the first network apparatus (200a) by performing intermittent Tx operation during gap in accordance with the reporting configuration provided by the first network apparatus (200a). Reporting operation may be performed by same Tx (e.g., Tx time-sharing, Tx time slicing or in accordance with suitable gap pattern) or by utilizing additional Tx capability of the UE (100)).

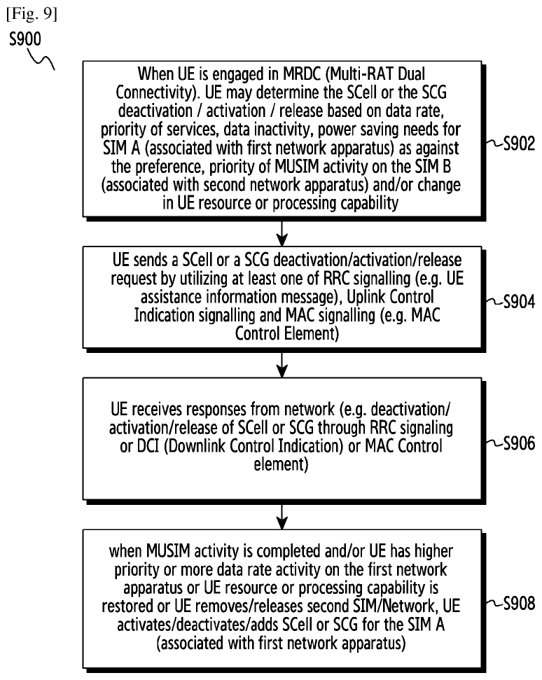

FIG. 9 is a flow chart (S900) illustrating a method for link management for the MUSIM UE (100) performing coordinated gaps based on the SCell or the SCG activation or deactivation or release, according to the embodiments as disclosed herein. The operations (S902-S908) are handled by the MUSIM coordinated gap controller (140).

At S902, When the UE (100) is engaged in MRDC (Multi-RAT Dual Connectivity). The UE (100) may determine the SCell or the SCG deactivation/activation/release based on the data rate, the priority of services, the data inactivity, the power saving needs for first SIM associated with the first network apparatus (200a) as against the preference, priority of MUSIM activity on the second SIM associated with the second network apparatus (200b) and/or change in the UE resource or processing capability.

At S904, the UE (100) sends a SCell or a SCG deactivation/activation/release request by utilizing at least one of RRC signalling (e.g., UE assistance information message), Uplink Control Indication signalling and MAC signalling (e.g., MAC Control Element). At S906, the UE (100) receives responses from the first network apparatus (200a) (The response can be, for example, but not limited to deactivation/activation/release of SCell or SCG through RRC signaling or DCI (Downlink Control Indication) or MAC Control element). At S908, when MUSIM activity is completed and/or UE (100) has higher priority or more data rate activity on the first network apparatus (200a) or the UE resource or processing capability is restored or the UE (100) removes/releases second SIM/Network, UE activates/deactivates/adds SCell or SCG for the first SIM associated with the first network apparatus (200a).

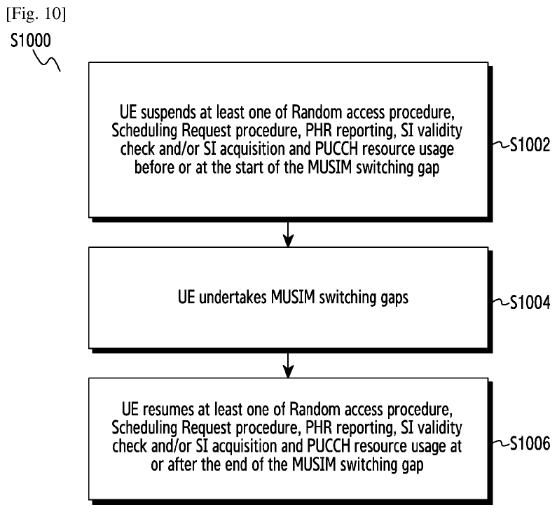

FIG. 10 is a flow chart (S1000) illustrating a method for link management for the MUSIM UE (100) performing coordinated gaps upon suspending at least one of the RA procedure, the SR procedure, the PHR reporting, the SI validation check or acquisition, and the PUCCH resource usage before or at the start of the switching gap, according to the embodiments as disclosed herein. The operations (S1002-S1006) are handled by the MUSIM coordinated gap controller (140).

At S1002, the UE (100) suspends at least one of random access procedure, Scheduling Request procedure, PHR reporting, SI validity check and/or SI acquisition and PUCCH resource usage before or at the start of the MUSIM switching gap. At S1004, the UE (100) undertakes MUSIM switching gaps. At S1006, the UE (100) resumes at least one of Random access procedure, Scheduling Request procedure, PHR reporting, SI validity check and/or SI acquisition and PUCCH resource usage at or after the end of the MUSIM switching gap.

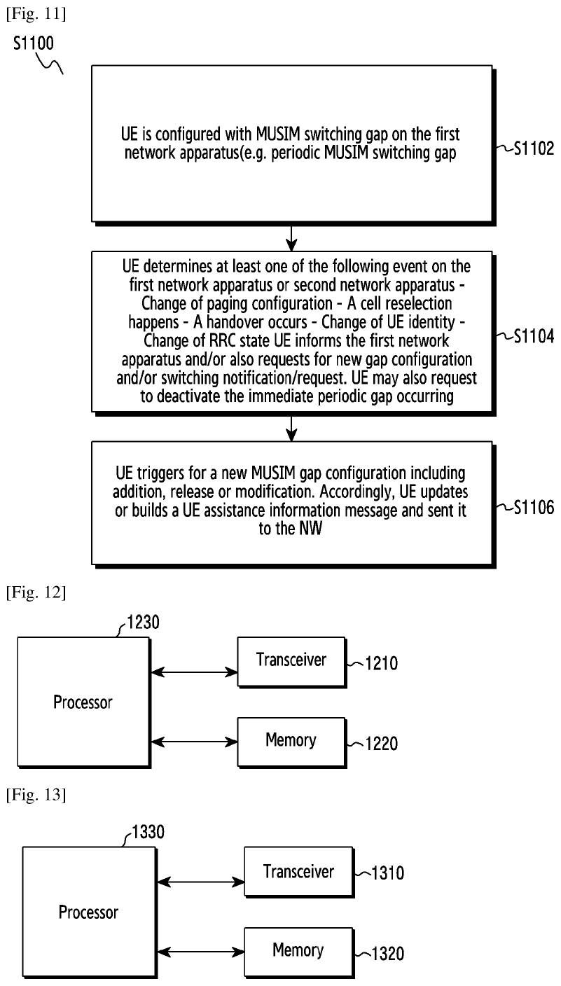

FIG. 11 is a flow chart (S1100) illustrating a method for link management for the MUSIM UE (100) performing coordinated gaps based on the change of paging configuration, reselection of the cell, the occurrence of the handover, the change in the identity of the MUSIM UE (100), and a change in RRC state of the MUSIM UE (100), according to the embodiments as disclosed herein. The operations (S1102-S1106) are handled by the MUSIM coordinated gap controller (140).

At S1102, the UE (100) is configured with the MUSIM switching gap (e.g., periodic MUSIM switching gap or the like) on the first network apparatus (200a). At S1104, the UE (100) determines at least one of the following events on the first network apparatus (200a) or the second network apparatus (100b). The event can be, for example, but not limited to a change of paging configuration, cell reselection happens, handover occurs, change of UE identity, Change of RRC state UE (100) informs the first network apparatus (200a) and/or also requests for new gap configuration and/or switching notification/request. The UE (100) may also request to deactivate the immediate periodic gap occurring. At S1106, the UE (100) triggers for a new MUSIM gap configuration including addition, release or modification. Accordingly, the UE (100) updates or builds a UE assistance information message and sent it to the first network apparatus (200a).

FIG. 12 is a block diagram of an internal configuration of a UE, according to an embodiment.

As shown in FIG. 12, the UE according to an embodiment may include a transceiver 1210, a memory 1220, and a processor 1230. The transceiver 1210, the memory 1220, and the processor 1230 of the UE may operate according to a communication method of the UE described above. However, the components of the UE are not limited thereto. For example, the UE may include more or fewer components than those described above. In addition, the processor 1230, the transceiver 1210, and the memory 1220 may be implemented as a single chip. Also, the processor 1030 may include at least one processor.

Furthermore, the UE of FIG. 12 corresponds to the UE of FIG. 3.

The transceiver 1210 collectively refers to a UE receiver and a UE transmitter, and may transmit/receive a signal to/from a base station or a network entity. The signal transmitted or received to or from the base station or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the UE. Also, the memory 1220 may store control information or data included in a signal obtained by the UE. The memory 1220 may be a storage medium, such as read-only memory (ROM), random access memory (RAM), a hard disk, a CD-ROM, and a DVD, or a combination of storage media.

The processor 1230 may control a series of processes such that the UE operates as described above. For example, the transceiver 1210 may receive a data signal including a control signal transmitted by the base station or the network entity, and the processor 1230 may determine a result of receiving the control signal and the data signal transmitted by the base station or the network entity.

FIG. 13 is a block diagram of an internal configuration of a base station, according to an embodiment.

As shown in FIG. 13, the base station according to an embodiment may include a transceiver 1310, a memory 1320, and a processor 1330. The transceiver 1310, the memory 1320, and the processor 1330 of the base station may operate according to a communication method of the base station described above. However, the components of the base station are not limited thereto. For example, the base station may include more or fewer components than those described above. In addition, the processor 1330, the transceiver 1310, and the memory 1320 may be implemented as a single chip. Also, the processor 1330 may include at least one processor.

The transceiver 1310 collectively refers to a base station receiver and a base station transmitter, and may transmit/receive a signal to/from a terminal or a network entity. The signal transmitted or received to or from the terminal or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the base station. Also, the memory 1320 may store control information or data included in a signal obtained by the base station. The memory 1320 may be a storage medium, such as read-only memory (ROM), random access memory (RAM), a hard disk, a CD-ROM, and a DVD, or a combination of storage media.

The processor 1330 may control a series of processes such that the base station operates as described above. For example, the transceiver 1310 may receive a data signal including a control signal transmitted by the terminal, and the processor 1330 may determine a result of receiving the control signal and the data signal transmitted by the terminal.

Accordingly, the embodiment herein is to provide a method for link management for a MUSIM UE performing coordinated gaps. The method includes establishing, by the MUSIM UE, a RRC connection with a first network apparatus. Further, the method includes detecting, by the MUSIM UE, a need to schedule activities associated with a second network apparatus. Further, the method includes determining, by the MUSIM UE, whether a switching gap or a RRC connection release or a RRC connection release with suspend configuration on the first network apparatus is required based on at least one of a MUSIM operation type and a required gap length for the activities associated with the second network apparatus. In an embodiment, the method includes sending a UE assistance information message comprising at least one requested switching gap information to the first network apparatus in response to determining that the switching gap is required, and receiving a MUSIM gap configuration comprising configured gap information from the first network apparatus. In another embodiment, the method includes sending a UE assistance information message comprising at least one requested switching gap release by a gap index to the first network apparatus in response to determining that the switching gap is not required, and receiving a MUSIM gap configuration comprising release of the switching gap with the gap index from the first network apparatus. In another embodiment, the method includes sending a UE assistance information message comprising a preferred RRC state to the first network apparatus in response to determining that the RRC connection release or the RRC connection release with suspend configuration is required, and receiving one of a RRC connection release and a RRC connection release with suspend configuration, wherein the preferred RRC state is one of an idle state, an inactive state, and a non-Connected state.

In another embodiment, determining RRC connection release or RRC connection release with suspend configuration on the first network apparatus is required includes detecting, by the MUSIM UE, at least one of the required gap length is greater than a maximum specified gap length and a MUSIM activity type is a specific MUSIM activity; and determining RRC connection release or RRC connection release with suspend configuration on the first network apparatus is required when at least one of the required gap length is greater than the maximum specified gap length and the MUSIM activity type is the specific MUSIM activity.

In another embodiment, sending the UE assistance information message comprising requested switching gap information to the first network apparatus includes determining, by the MUSIM UE, at least one of a periodic gap length, an aperiodic gap length, a gap index, a gap offset, and a gap repetition based on a specified gap length associated with the second network apparatus, and sending, by the MUSIM UE, the MUSIM UE assistance information message comprising the requested switching gap information to the first network apparatus, wherein the requested switching gap information comprises at least one of the determined periodic gap length, the determined aperiodic gap starting System Frame Number (SFN) and starting sub-frame, the determined aperiodic gap length, the determined gap index, the determined gap offset, and the determined gap repetition.

In another embodiment, the configured gap information comprises at least one of a configured gap index, a configured gap offset, a configured gap repetition, a configured periodic gap length, a configured aperiodic gap starting System Frame Number (SFN) and starting sub-frame, and a configured aperiodic gap length.

In another embodiment, sending the UE assistance information message comprising the requested switching gap release by a gap index to the first network apparatus includes sending, by the MUSIM UE, the UE assistance information message to the first network apparatus when a periodic switching gap is to be released, and skipping sending, by the MUSIM UE, the UE assistance information message to the first network apparatus when an aperiodic switching gap is to be released and implicitly release the aperiodic switching gap after the gap period is over for the aperiodic switching gap.

In an embodiment, the method includes detecting, by the MUSIM UE, whether the switching gap is initiated to perform the activities on the second network apparatus. Further, the method includes managing, by the MUSIM UE, at least one of a Transmission (Tx)-Reception (Rx) related timer, a Quality of Service (QOS) related timer, and a mobility related timer in response to detecting the initiation of the switching gap. Further, the method includes performing, by the MUSIM UE, at least one action, wherein the at least one action includes stop at least one of the Tx-Rx related timer, the QoS related timer, and the mobility related timer at a beginning of the switching gap, and start or restart at least one of the Tx-Rx related timer, the QoS related timer, and the mobility related timer at an end of the switching gap, stop at least one of the Tx-Rx related timer, the QoS related timer, and the mobility related timer at a beginning of the switching gap, and resume at least one of the Tx-Rx related timer, the QoS related timer, and the mobility related timer from a previous timer value at an end of the switching gap, continue to run at least one of the Tx-Rx related timer, the QoS related timer, and the mobility related timer during the switching gap, hold any resultant action until the switching gap end when at least one of the Tx-Rx related timer, the QoS related timer, and the mobility timer expires during the switching gap and start or restart at least one of the Tx-Rx related timer, the QoS related timer, and the mobility related timer at an end of the switching gap, continue to run at least one of the Tx-Rx related timer, the QoS related timer, and the mobility related timer, and extend the timer value by adding the switching gap duration so that timer is not expired during the switching gap, continue to run at least one of the Tx-Rx related timer, the QoS related timer, and the mobility related timer during the switching gap, skip performing any resultant action when at least one of the Tx-Rx related timer, the QoS related timer, and the mobility timer expires during the switching gap and start or restart at least one of the Tx-Rx related timer, the QoS related timer, and the mobility related timer at an end of the switching gap.

In an embodiment, the method includes detecting, by the MUSIM UE, an initiation of the switching gap to perform the MUSIM activities on the second network apparatus. Further, the method includes determining, by the MUSIM UE, whether Hybrid Automatic Repeat Request (HARQ) buffers are shared across two protocol stacks pertaining to two SIMs of the MUSIM UE. Further, the method includes performing, by the MUSIM UE, one of: flushing, by the MUSIM UE, at least one of downlink (DL) and uplink (UL) HARQ buffers at time of the switching gap in response to determining that the HARQ buffers are shared across the two protocol stacks pertaining to the two SIMs of the MUSIM UE, and avoid flushing, by the MUSIM UE, at least one of DL and UL HARQ buffers at time of the switching gap in response to determining that the HARQ buffers are not shared across the two protocol stacks pertaining to the two SIMs of the MUSIM UE.

In an embodiment, the method includes detecting, by the MUSIM UE, an initiation of the switching gap to perform the MUSIM activities on the second network apparatus. Further, the method includes performing, by the MUSIM UE, intermittent Rx operation and at least one of measurements and a Channel State Information (CSI) evaluation during the switching gap in accordance with resources as configured by the first network apparatus. Further, the method includes reporting, by the MUSIM UE, measurement results and CSI feedback to the first network apparatus by performing intermittent Tx operation during the switching gap in accordance with the reporting configuration provided by the first network apparatus.

In an embodiment, the method includes determining, by the MUSIM UE, a Secondary SCell or a Secondary Cell Group (SCG) activation or deactivation or release based on at least one of a data rate, a priority of service, data inactivity, power saving requirement for a first SIM associated with the first network apparatus, a priority of MUSIM activity on a second SIM associated with the second network apparatus, and a change in UE capability and resources. Further, the method includes sending, by the MUSIM UE, a SCell or a SCG activation or deactivation or release request to the first network apparatus by utilizing at least one of RRC signaling, UCI signaling, and MAC signaling. Further, the method includes receiving, by the MUSIM UE, a SCell or a SCG activation or deactivation or release in response from the first network apparatus. Further, the method includes performing, by the MUSIM UE, a SCell or a SCG activation or deactivation or release as received from the first network apparatus. Further, the method includes activating, by the MUSIM UE, the deactivated SCell or SCG for the first SIM associated with the first network apparatus when at least one of a MUSIM activity is completed, the MUSIM UE has higher priority, the MUSIM UE has more data rate activity on the first network apparatus, resources or processing capabilities of the MUSIM UE is restored, and the MUSIM UE removes or releases the second SIM associated with the second network apparatus.

In an embodiment, the method includes detecting, by the MUSIM UE, an initiation of the switching gap to perform the MUSIM activities on the second network apparatus. Further, the method includes suspending, by the MUSIM UE, at least one of a random access (RA) procedure, a scheduling request (SR) procedure, a Power Headroom Report (PHR) reporting, a System Information (SI) validation check or acquisition, and a Physical Uplink Control Channel (PUCCH) resource usage before or at the start of the switching gap. Further, the method includes detecting, by the MUSIM UE, an end of the switching gap. Further, the method includes resuming, by the MUSIM UE, at least one of the random access procedure, the scheduling request procedure, the PHR reporting, the SI validation check or acquisition, and the PUCCH resource usage at the end of the switching gap.

In an embodiment, the method includes detecting, by the MUSIM UE, an initiation of the switching gap to perform the MUSIM activities on the second network apparatus. Further, the method includes detecting, by the MUSIM UE, an event on one of the first network apparatus and the second network apparatus, wherein the event comprises at least one of a change of paging configuration, reselection of a cell, an occurrence of a handover, a change in an identity of the MUSIM UE, and a change in RRC state of the MUSIM UE. Further, the method includes triggering, by the MUSIM UE, a switching gap request for a new MUSIM gap configuration or a release of MUSIM gap configuration or a modification of MUSIM gap configuration.

Accordingly, the embodiment herein is to provide a MUSIM UE for link management to perform coordinated gaps. The MUSIM UE includes a MUSIM coordinated gap controller communicatively coupled to a memory and a processor. Further, the MUSIM coordinated gap controller is configured to establish a RRC connection with a first network apparatus. Further, the MUSIM coordinated gap controller is configured to detect a need to schedule activities associated with a second network apparatus. Further, the MUSIM coordinated gap controller is configured to determine whether a switching gap or a RRC connection release or RRC connection release with suspend configuration on the first network apparatus is required based on at least one of a MUSIM operation type and a required gap length for the activities associated with the second network apparatus. In an embodiment, the MUSIM coordinated gap controller is configured to send a UE assistance information message comprising at least one requested switching gap information to the first network apparatus in response to determining that the switching gap is required, and receiving a MUSIM gap configuration comprising configured gap information from the first network apparatus. In another embodiment, the MUSIM coordinated gap controller is configured to send a UE assistance information message comprising at least one requested switching gap release by a gap index to the first network apparatus in response to determining that the switching gap is not required, and receiving a MUSIM gap configuration comprising release of the switching gap with the gap index from the first network apparatus. In another embodiment, the MUSIM coordinated gap controller is configured to send a UE assistance information message comprising a preferred RRC state to the first network apparatus in response to determining that the RRC connection release or RRC connection release with suspend configuration is required, and receiving one of a RRC connection release and a RRC connection release with suspend configuration, wherein the preferred RRC state is one of an idle state, an inactive state, and a non-Connected state.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a User Equipment (UE) in a wireless communication system, wherein the method comprising:
receiving, from a first base station of a first network, first configuration information associated with a Multi-Universal Subscriber Identity Module (MUSIM) operation with the first network and a second network;
transmitting, to the first base station, first assistance information including a preferred gap configuration, based on the first configuration information;
receiving, from the first base station, second configuration information including gap configuration for the MUSIM operation configured based on the first assistance information.

17. The method of claim 16, further comprising:
transmitting, to the first base station, second assistance information associated with an RRC state for the MUSIM operation, based on the first configuration information, the second assistance information includes information on a preferred RRC state of the UE when an RRC connected state is released.

18. The method of claim 16, wherein the preferred gap configuration included in the first assistance information includes at least one of information on preferred length of a gap for the MUSIM operation, information on preferred repetition period of the gap, information on a preferred subframe offset of the gap, or information on preferred start time of the gap.

19. The method of claim 18, wherein the gap configuration included in the second configuration information includes at least one of information on length of a gap for the MUSIM operation, information on repetition period of the gap, information on a subframe offset of the gap, or information on preferred start time of the gap.

20. The method of claim 16, further comprising:
identifying that the preferred gap configuration included in the first assistance information is changed; and
transmitting, to the first base station, second assistance information which is changed from the first assistance information.

21. A method performed by a first base station of a first network in a wireless communication system, wherein the method comprising:
transmitting, to a user equipment (UE), first configuration information associated with a Multi-Universal Subscriber Identity Module (MUSIM) operation with the first network and a second network;
receiving, from the UE, first assistance information including a preferred gap configuration, based on the first configuration information;
transmitting, to the UE, second configuration information including gap configuration for the MUSIM operation configured based on the first assistance information.

22. The method of claim 21, further comprising:
receiving, from the UE, second assistance information associated with an RRC state for the MUSIM operation, based on the first configuration information, the second assistance information includes information on a preferred RRC state of the UE when a RRC connected state is released.

23. The method of claim 21, wherein the preferred gap configuration included in the first assistance information includes at least one of information on preferred length of a gap for the MUSIM operation, information on preferred repetition period of the gap, information on a preferred subframe offset of the gap, or information on preferred start time of the gap.

24. The method of claim 23, wherein the gap configuration included in the second configuration information includes at least one of information on length of a gap for the MUSIM operation, information on repetition period of the gap, information on a subframe offset of the gap, or information on preferred start time of the gap.

25. The method of claim 21, further comprising:
in case that the preferred gap configuration included in the first assistance information is changed, receiving from the UE, second assistance information which is changed from the first assistance information.

26. A user equipment (UE) in a wireless communication system, the UE comprising:
a transceiver; and
a controller coupled with the transceiver and configured to:
receive, from a first base station of a first network, first configuration information associated with a Multi-Universal Subscriber Identity Module (MUSIM) operation with the first network and a second network;
transmit, to the first base station, first assistance information including a preferred gap configuration, based on the first configuration information;
receive, from the first base station, second configuration information including gap configuration for the MUSIM operation configured based on the first assistance information.

27. The UE of claim 26, the controller is configured to:
transmit, to the first base station, second assistance information associated with an RRC state for the MUSIM operation, based on the first configuration information, the second assistance information includes information on a preferred RRC state of the UE when an RRC connected state is released.

28. The UE of claim 26, wherein the preferred gap configuration included in the first assistance information includes at least one of information on preferred length of a gap for the MUSIM operation, information on preferred repetition period of the gap, information on a preferred subframe offset of the gap, or information on preferred start time of the gap.

29. The UE of claim 28, wherein the gap configuration included in the second configuration information includes at least one of information on length of a gap for the MUSIM operation, information on repetition period of the gap, information on a subframe offset of the gap, or information on preferred start time of the gap.

30. The UE of claim 26, the controller is further configured to:
identify that the preferred gap configuration included in the first assistance information is changed; and
transmit, to the first base station, second assistance information which is changed from the first assistance information.

31. A first base station of a first network in a wireless communication system, the base station comprising:
a transceiver; and
a controller coupled with the transceiver and configured to:
transmit, to a user equipment (UE), first configuration information associated with a Multi-Universal Subscriber Identity Module (MUSIM) operation with the first network and a second network;
receive, from the UE, first assistance information including a preferred gap configuration, based on the first configuration information;
transmit, to the UE, second configuration information including gap configuration for the MUSIM operation configured based on the first assistance information.

32. The first base station of claim 31, the controller is further configured to:
receive, from the UE, second assistance information associated with an RRC state for the MUSIM operation, based on the first configuration information, the second assistance information includes information on a preferred RRC state of the UE when a RRC connected state is released.

33. The first base station of claim 31, wherein the preferred gap configuration included in the first assistance information includes at least one of information on preferred length of a gap for the MUSIM operation, information on preferred repetition period of the gap, information on a preferred subframe offset of the gap, or information on preferred start time of the gap.

34. The first base station of claim 33, wherein the gap configuration included in the second configuration information includes at least one of information on length of a gap for the MUSIM operation, information on repetition period of the gap, information on a subframe offset of the gap, or information on preferred start time of the gap.

35. The first base station of claim 31, the controller is further configured to:
in case that the preferred gap configuration included in the first assistance information is changed, receive from the UE, second assistance information which is changed from the first assistance information.
